(19) United States
(12) Patent Application Publication
(10) Pub. No.: US 2026/0359694 A1
(43) Pub. Date: Nov. 12, 2026

(54) Modular Quantum Processing Units with Logical Qubits

(71) Applicant: Rigetti & Co, LLC, Berkeley, CA (US)

(72) Inventor: Matthew J. Reagor, San Rafael, CA (US)

(73) Assignee: Rigetti & Co, LLC, Berkeley, CA (US)

(21) Appl. No.: 18/597,439

(22) Filed: Mar. 6, 2024

Related U.S. Application Data
(63) Continuation of application No. PCT/US22/42943, filed on Sep. 8, 2022.
(60) Provisional application No. 63/241,595, filed on Sep. 8, 2021.

(51) Int. Cl. G06N 10/40; G06N 10/20; G06N 10/60

(52) U.S. Cl. CPC G06N 10/40; G06N 10/20; G06N 10/60

(57) ABSTRACT

In a general aspect, a modular quantum processing unit with quantum processing hardware modules is described. In some implementations, a computing system includes a modular quantum processing unit and a control system. The modular quantum processing unit includes quantum processor chips, a substrate that supports the quantum processor chips. Each quantum processor chip includes a superconducting quantum circuit; and each superconducting quantum circuit includes intra-chip circuit connections between respective pairs of quantum circuit devices within the superconducting quantum circuit.

The substrate includes circuitry which includes inter-chip circuit connections between respective pairs of the quantum circuit devices in distinct quantum processor chips. The control system is configured to apply quantum error correction to logical qubits defined by each respective subset of the quantum processor chips.

### CROSS-REFERENCE TO RELATED APPLICATIONS

This application is a continuation of International Application PCT/US2022/042943, filed Sep. 8, 2022, which claims priority to U.S. Provisional Patent Application No. 63/241,595, filed Sep. 8, 2021, entitled “Modular Quantum Processing Units with Logical Qubit Hardware Modules.” The above-referenced priority document is incorporated herein by reference in its entirety.

### TECHNICAL FIELD

The following description relates generally to modular quantum processing units with logical qubits,

### BACKGROUND

Quantum computers can perform computational tasks by storing and processing information within quantum states of quantum systems. For example, qubits (i.e., quantum bits) can be stored in, and represented by, an effective two-level sub-manifold of a quantum coherent physical system. A variety of physical systems have been proposed for quantum computing applications. Examples include superconducting circuits, trapped ions, spin systems, and others.

### BRIEF DESCRIPTION OF THE DRAWINGS

FIG. 1 is a block diagram of an example computing environment.

FIG. 2 is a block diagram showing an example modular quantum processing unit.

FIG. 3 is a block diagram showing aspects of an example modular quantum processing unit.

FIG. 4 is a schematic diagram of an example quantum error correction code (QECC) layout.

FIG. 5 is a block diagram showing aspects of an example quantum computing system.

FIG. 6 is a block diagram showing aspects of an example modular quantum processing unit.

### DETAILED DESCRIPTION

In some aspects of what is described here, a modular quantum processing unit includes multiple distinct quantum processor chips. The quantum processor chips can be distinct hardware components that are coupled together, for example, across their boundaries. The quantum processor chips may be designed, fabricated, tested, and selected individually, in batches, or otherwise. In some implementations, each of the quantum processor chips may include distinct types of quantum circuit devices or functionalities. In some cases, quantum processor chips may be bonded (e.g., using bonding bumps, bonding pads, through-silicon signal vias, or a combination thereof) to a substrate (e.g., silicon, sapphire, etc.) in a modular quantum processing unit. The substrate may include signal lines as well as coupler structures (e.g., superconducting traces or transmission lines) in or on the substrate that allow the quantum processor chips to communicate with each other and communicate with a control system.

In some implementations, deploying qubit devices across multiple quantum processor chips can provide an improved spatial layout for connecting the qubit devices to a control system. In some implementations, each of the quantum processor chips in a modular quantum processing unit includes multiple qubit devices and possibly other quantum circuit devices. By networking or otherwise grouping multiple qubit devices of one or more quantum processor chips together, a logical qubit can be defined. In some implementations, the multiple qubit devices in one or more quantum processor chips working collectively to define a logical qubit are connected in an error correction pattern. In some aspects, the logical qubit defined by the multiple qubit devices can facilitate an error correction mechanism. In some instances, a single logical qubit can be defined by networking multiple qubit devices across distinct quantum processor chips (in whole or in part) in an error check pattern.

In some implementations, the systems and techniques described here can provide technical advantages and improvements. For example, the methods and techniques presented here can increase overall manufacturing yields and enable large scale quantum computers which utilize multiple logical qubits. The methods and techniques presented here can combine a “modular” error correction architecture and a “modular” manufacturing approach, which can provide large scale error correction to a modular quantum processing unit, enabling faster processing speed and lower physical overheads (e.g., cost or complexity of scale). In some cases, a combination of these and potentially other advantages and improvements may be obtained.

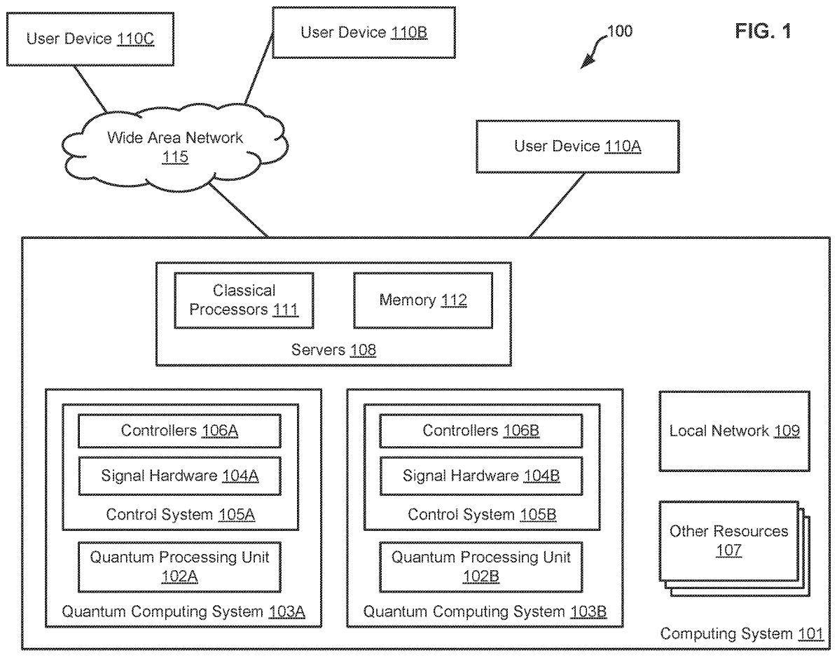

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, quantum processor chip data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B, and the other resources 107 may communicate with each other through the local network 109. In some implementations, the local network 109 operates as a communication channel that provides one or more low-latency communication pathways from the server 108 to the quantum computing systems 103A, 103B (or to one or more of the elements of the quantum computing systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remote from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B, and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features, and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution, For example, the servers 108 may send programs to the quantum computing system 103A, the quantum computing system 103B, or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv:1608.03355v 2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format. In some cases, a program may utilize Quil-T, described in the publication “Gain deeper control of Rigetti quantum processing units with Quil-T,” available at https://medium.com/rigetti/gain-deeper-control-of-rigetti-quantum-processors-with-quil-t-ea8945061e5b dated Dec. 10, 2020, which is hereby incorporated by reference in the present disclosure.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110; or perform another type of action.

In some implementations, all or part of the computing environment operates as a cloud-based quantum computing (QC) environment, and the servers 108 operate as a host system for the cloud-based QC environment. The cloud-based QC environment may include software elements that operate on both the user devices 110 and the computer system 101 and interact with each other over the wide area network 115. For example, the cloud-based QC environment may provide a remote user interface, for example, through a browser or another type of application on the user devices 110. The remote user interface may include, for example, a graphical user interface or another type of user interface that obtains input provided by a user of the cloud-based QC environment. In some cases, the remote user interface includes, or has access to, one or more application programming interfaces (APIs), command line interfaces, graphical user interfaces, or other elements that expose the services of the computer system 101 to the user devices 110.

In some cases, the cloud-based QC environment may be deployed in a “serverless” computing architecture. For instance, the cloud-based QC environment may provide on-demand access to a shared pool of configurable computing resources (e.g., networks, servers, storage, applications, services, quantum computing resources, classical computing resources, etc.) that can be provisioned for requests from user devices 110. Moreover, the cloud-based computing systems 101 may include or utilize other types of computing resources, such as, for example, edge computing, fog computing, etc.

In an example implementation of a cloud-based QC environment, the servers 108 may operate as a cloud provider that dynamically manages the allocation and provisioning of physical computing resources (e.g., GPUs, CPUs, QPUs, etc.). Accordingly, the servers 108 may provide services by defining virtualized resources for each user account. For instance, the virtualized resources may be formatted as virtual machine images, virtual machines, containers, or virtualized resources that can be provisioned for a user account and configured by a user. In some cases, servers 108 include a container management and execution system that is implemented, for example, using KUBERNETES® or another software platform for container management. In some cases, the cloud-based QC environment is implemented using a resource such as, for example, OPENSTACK®. OPENSTACK® is an example of a software platform for cloud-based computing, which can be used to provide virtual servers and other virtual computing resources for users.

In some cases, the server 108 stores quantum machine images (QMI) for each user account. A quantum machine image may operate as a virtual computing resource for users of the cloud-based QC environment. For example, a QMI can provide a virtualized development and execution environment to develop and run programs (e.g., quantum programs or hybrid classical/quantum programs). When a QMI operates on the server 108, the QMI may engage either of the quantum processing units 102A, 102B, and interact with a remote user device (110B or 110C) to provide a user programming environment. The QMI may operate in close physical proximity to, and have a low-latency communication link with, the quantum computing systems 103A, 103B. In some implementations, remote user devices connect with QMIs operating on the servers 108 through secure shell (SSH) or other protocols over the wide area network 115.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors, In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correction schemes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

In some instances, all or part of the quantum processing unit 102A functions as a quantum processing unit, a quantum memory, or another type of subsystem. In some examples, the quantum processing unit 102A includes a quantum circuit system. The quantum circuit system may include qubit devices, readout devices, and possibly other devices that are used to store and process quantum information. In some cases, the quantum processing unit 102A includes a superconducting circuit, and the superconducting circuit includes qubit devices operatively coupled to each other by coupler devices. In certain examples, the qubit devices and the coupler devices are implemented as quantum circuit devices that include Josephson junctions, for example, in Superconducting QUantum Interference Device (SQUID) loops or other arrangements, and are controlled by radio-frequency signals, microwave signals, and bias signals delivered to the quantum processing unit 102A.

In some implementations, the example quantum processing unit 102 includes multiple quantum processor chips. For example, the quantum processing unit 102 may include a two-dimensional or three-dimensional array of quantum processor chips, and each quantum processor chip may include an array of quantum circuit devices. In this case, the example quantum processing unit 102 is a modular quantum processing unit. In some cases, the quantum processor chips may be supported on a common substrate and may be connected through superconductive circuitry on the common substrate.

In some instances, each of the quantum processor chips can include a superconducting quantum circuit that includes one or more quantum circuit devices for performing quantum operations, as may be actuated by a controller in a quantum computer system. For instance, a superconducting quantum circuit of a quantum processor chip may include qubit devices, readout resonator devices, Josephson junctions, or other quantum circuit devices. In some implementations, quantum processor chips are fabricated in batches by a high-volume fabrication process. In some implementations, each individual quantum processor chip in a modular quantum processing unit 102 can function independently as a small quantum processing unit. In some implementations, quantum circuit devices in the same quantum processor chip or in different quantum processor chips can be collectively operated to define a single logical qubit. A logical qubit comprises a quantum register, for instance multiple physical qubits or qudits, and associated circuitry, that supports physical operations which can be used to detect or correct errors associated with logical states in a quantum algorithm. Physical operations in a quantum logic circuit supported by the quantum register associated with a logical qubit may include single-qubit or multi-qubit quantum logic gates and readout operations. Error detection or correction mechanisms associated with a logical qubit may be based on quantum error correction schemes such as the surface code, color code, Bacon-Shor codes, low-density parity check codes (LDPC), some combination of these, or others. A single quantum processor chip can be deployed as an individual hardware component, for example, a logical qubit die that can define one or more logical qubits. In some cases, a single logical qubit die includes a multitude of physical quantum circuit elements (e.g., qubit devices and corresponding couplers) that can operate as a single logical qubit, and the logical qubit die may also include connections that allow the circuit to communicate with other logical qubit dies, themselves each supporting at least one logical qubit. In some instances, quantum circuit elements from distinct logical qubit dies can work collectively together to define a single logical qubit. In this case, the distinct logical qubit dies can be supported on a common substrate; and inter-chip circuit connections communicably coupling quantum circuit elements from the distinct logical qubit dies can be provided on the common substrate.

In some implementations, quantum processor chip data that characterizes one or more quantum processor chips that are networked together to define a logical qubit, for example, by inter-chip circuit connections on a common substrate, is stored in the memory 112 of the server 108. In certain instances, quantum processor chip data may be stored on or obtained by a user device 110, the control system 105 of the quantum computing system 103, or any other computer-readable medium of the computing environment 100. In some instances, quantum processor chip data may be generated by the server 108 according to the types and properties of the quantum processor chips in the quantum processing units 102, the connectivity among the quantum processor chips, or may be defined by the user device 110 according to a specific quantum algorithm. In some instances, the quantum processor chip data may be generated or obtained in another manner. In some instances, quantum processor chip data may be used, for example, by the control system 105 of the quantum computing system 103, to define control sequencies for performing operations, such as activating or deactivating inter-chip or intra-chip circuit connections to define logical qubits, or in another manner.

In certain approaches to error corrected algorithms, such as with the surface code, logical qubits may actuate operations, such as those associated with lattice surgery, including MERGE or SPLIT operations, which temporarily delocalize logical qubits from specific physical qubit registers in order to perform multi-qubit operations, such as entangling quantum logic gates, between logical qubits, or to perform data movement operations of logical qubits. Nonetheless, quantum processor chips associated with individual tiles or patches of such schemes are recognizable as logical qubit dies if they may be initialized to support or operate individual logical qubits.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations,

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computing system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radio-frequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning, or other operations on readout signals received from the quantum processing unit 102A.

The example controllers 106A communicate with the signal hardware 104A to control operation of the quantum computing system 103A. The controllers 106A may include classical computing hardware that directly interface with components of the signal hardware 104A. The example controllers 106A may include classical processors, memory, clocks, digital circuitry, analog circuitry, and other types of systems or subsystems. The classical processors may include one or more single-or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitstrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computing system 103B and its components (e.g., the quantum processing unit 102B, the signal hardware 104B, and controllers 106B) can be implemented as described above with respect to the quantum computing system 103A; in some cases, the quantum computing system 103B and its components may be implemented or may operate in another manner.

In some implementations, the quantum computing systems 103A, 103B are disparate systems that provide distinct modalities of quantum computation. For example, the computer system 101 may include both an adiabatic quantum computing system and a gate-based quantum computer system. As another example, the computer system 101 may include a superconducting circuit-based quantum computing system and an ion trap-based quantum computer system. In such cases, the computer system 101 may utilize each quantum computing system according to the type of quantum program that is being executed, according to availability or capacity, or based on other considerations.

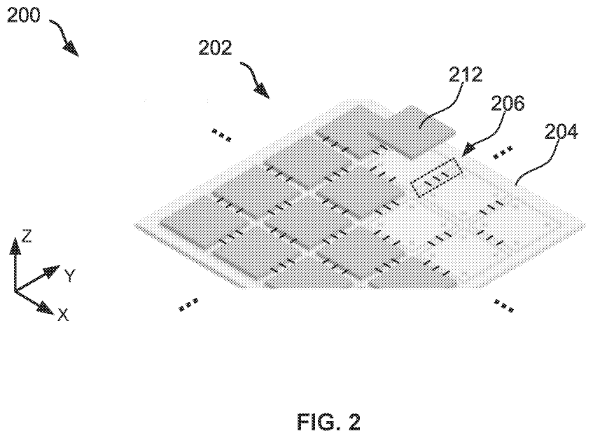

FIG. 2 is a block diagram showing a perspective view of an example modular quantum processing unit 200. The example modular quantum processing unit 200 includes one or more quantum processor modules 202. In some instances, the quantum processor modules 202 may be integrated on a common plate which includes inter-module coupler devices and other circuit element allowing the quantum processor modules to be communicably coupled to one another. Each of the quantum processor modules 202 in the example modular quantum processing unit 200 includes an array of quantum processor chips 212. As shown in FIG. 2, neighboring pairs of quantum processor chips 202 are connected to each other through inter-chip circuit connections 206. The inter-chip circuit connections 206 can include capacitive, inductive, or galvanic circuit connections, or combinations of these. The inter-chip circuit connections 206 are provided by circuitry on the substrate 204, which is operably connected to ports, leads, bonds or other types of hardware interfaces on the respective quantum processor chips 212. Couplings provided by inter-chip circuit connections 206 can be used to apply multi-qubit quantum logic gates or other types of operations to qubits in distinct quantum processor chips. The quantum logic gates mediated by inter-chip circuit connections 206 may be used to provide entanglement between qubits in distinct quantum processor chips 212; in some cases, other schemes such as remote multi-qubit measurement can be used to entangle qubits in distinct quantum processor chips 212. In some implementations, couplings provided by inter-chip circuit connections 206 can be used to apply quantum logic gates to logical qubits collectively defined by qubit devices on one or more respective quantum processor chips 212. The quantum processor chips 212 of the quantum processor module 202 can be arranged on the substrate 204 as an array in a two-dimensional or three-dimensional lattice structure. Eleven of the quantum processor chips 212 in the quantum processor module 202 are shown in FIG. 2, but the quantum processor module 202 is scalable to include many more quantum processor chips (e.g., tens, hundreds, thousands, etc.). In some instances, a subset of the quantum processor chips may be supported on a common substrate 204. In some implementations, the example modular quantum processing unit 200 may include additional and different features or components and components of the example modular quantum processing unit 200 may be implemented in another manner.

In the example shown in FIG. 2, the quantum processor chips 212 are arranged in a rectilinear (e.g., rectangular or square) array on the substrate 204 that extends in two spatial dimensions (e.g., along the X-Y plane) on a surface of the substrate 204. In some implementations, the quantum processor chips 212 can be arranged in another type of ordered array. In some instances, the rectilinear array also extends in a third spatial dimension (e.g., along the Z axis), for example, to form a cubic array or another type of three-dimensional module assembly.

In some implementations, each of the quantum processor chips 202 in the quantum processor module 202 of the modular quantum processing unit 200 includes a superconducting quantum circuit. In some implementations, a superconducting quantum circuit of a quantum processor chip 212 includes one or more qubit devices that can operate collectively as a logical qubit, or multiple subsets of qubit devices of a quantum processor chip can operate as multiple logical qubits, for example, by operation of the control system 105 as shown in FIG. 1. In some implementations, multiple qubit devices from different quantum processor chips can operate as a single logical qubit. In certain instances, a qubit device in the superconducting quantum circuit of a quantum processor chip 212 may be a fixed-frequency qubit device or a tunable-frequency qubit device. In some instances, the superconducting quantum circuit may also include coupler devices, readout resonator devices, or other types of quantum circuit devices. In some examples, each of the qubit devices in a quantum processor chip 212 can be encoded with a single bit of quantum information.

Typically, each of the qubit devices in a quantum processor chip 212 has two eigenstates that are used as computational basis states (e.g., |0> and |1>), and each qubit device can transition between its computational basis states or exist in an arbitrary superposition of its computational basis states. In some examples, the two lowest energy levels (e.g., the ground state and first excited state) of each qubit device are defined as a qubit and used as computational basis states for quantum computation. In some examples, higher energy levels (e.g., a second excited state or a third excited state) can be used to define a qubit, a qutrit, or a multi-level quantum computational device in some instances. Quantum states (e.g., qubits) defined by respective qubit devices in a single quantum processor chip 212 can be manipulated by control signals, or read by readout signals, generated by a control system, e.g., the control system 504. The qubit devices in a single quantum processor chip 212 can be controlled individually, for example, by delivering control signals from a control system to the respective qubit devices in the single quantum processor chip 212. In some cases, readout devices can detect the states of the qubit devices, for example, by interacting directly with the respective qubit devices.

Although each individual qubit device defines a single qubit, a lattice of qubit devices from the same quantum processor chip 212 or qubit devices from different quantum processor chips 212, when connected in an error check pattern, can operate collectively as a single logical qubit. In this case, a stabilizer code or another type of quantum error correction scheme can be applied to the lattice of qubit devices, for example, by operation of a control system, according to the error check pattern. In some cases, one of the qubit devices operates as a data qubit device, other qubit devices in the lattice operate as ancilla (or parity-check qubit devices or stabilizer qubit devices, and a quantum error correction scheme is applied to the lattice of qubit devices. The ancilla qubit devices may be used to detect an error syndrome, which can be used to correct errors on the data qubit devices. Examples of stabilizer codes include surface codes, color codes and other types of quantum error correction codes. Accordingly, a quantum processor chip 212 may include qubit devices, connections among the qubit devices, and potentially other hardware features that define an appropriate lattice for one or more quantum error correction codes to be applied.

In some instances, all of the quantum processor chips 212 may include the same superconducting quantum circuit with the same circuit design and the same functionality. For example, two quantum processor chips 212 in the quantum processor module 202 may include identical circuit design, e.g., the same number of qubit devices, arrangements of signal lines, etc. In this case, two quantum processor chips 212 in the quantum processor module 202 may be fabricated through the same fabrication process.

In certain instances, the quantum processor chips 212 may include different superconducting quantum circuits with distinct circuit designs and distinct functionalities. For example, two quantum processor chips 212 in the quantum processor module 202 have different numbers of qubit devices, different connections (e.g., different intra-chip circuit connections) between qubit devices, different arrangements of signal lines, etc. In this case, two quantum processor chips 212 in the quantum processor module 202 are fabricated using different fabrication processes. In some cases, multiple different fabrication processes are used to produce a batch of quantum processor chips 212. In certain instances, design and fabrication processes of superconducting quantum circuits of different quantum processor chips 212 may be separately optimized. Example embodiments of the quantum processor chip data discussed above may include data indicative of these differences between the superconducting quantum circuits of the quantum processor chips.

In some instances, after fabrication, the quantum processor chips 212 may be evaluated, for example, using qubit frequency testing, optical micrograph analysis, gate performance testing, coherence time testing, and other types of testing. The evaluations can be used to characterize the quantum processor chips according to their design specifications. In some cases, the quantum processor chips may be categorized based on the evaluation results. For example, quantum processor chips may be sorted into multiple categories based on pre-determined criteria for each category. In some cases, the categories are indicative of a relative quality of a quantum processor chip. In some cases, the categories are indicative of a functionality of a quantum processor chip, the number of working qubit devices in a quantum processor chip 212, or a combination of these and other criteria. A subset of the quantum processor chips 212 may be selected from appropriate categories based on a specified performance level for the modular quantum processing unit 200.

The superconducting quantum circuit in a quantum processor chip 212 shown in FIG. 2 is fabricated on a substrate. In certain instances, the substrate supporting the superconducting quantum circuit in a quantum processor chip 212 may be an elemental semiconductor, for example silicon (Si), germanium (Ge), selenium (Se), tellurium (Te), or another elemental semiconductor. In some instances, the substrate may also include a compound semiconductor such as aluminum oxide (sapphire), silicon carbide (SiC), gallium arsenic (GaAs), indium arsenide (InAs), indium phosphide (InP), silicon germanium (SiGe), silicon germanium carbide (SiGeC), gallium arsenic phosphide (GaAsP), gallium indium phosphide (GaInP), or another compound semiconductor. In some instances, the substrate may also include a superlattice with elemental or compound semiconductor layers. In certain instances, the substrate includes an epitaxial layer. In some examples, the substrate may have an epitaxial layer overlying a bulk semiconductor or may include a semiconductor-on-insulator (SOI) structure.

The superconducting quantum circuit in a quantum processor chip 212 may include superconductive materials and can be formed by patterning one or more superconductive (e.g., superconducting metal) layers or other materials on the surface of the substrate. In some implementations, each of the one or more superconductive layers include a superconducting metal, such as aluminum (Al), niobium (Nb), tantalum (Ta), titanium (Ti), vanadium (V), tungsten (W), zirconium (Zr), or another superconducting metal. In some implementations, each of the one or more superconductive layers may include a superconducting metal alloy, such as molybdenum-rhenium (Mo/Re), niobium-tin (Nb/Sn), or another superconducting metal alloy. In some implementations, each of the superconductive layers may include a superconducting compound material, including superconducting metal nitrides and superconducting metal oxides, such as titanium-nitride (TiN), niobium-nitride (NbN), zirconium-nitride (ZrN), hafnium-nitride (HfN), vanadium-nitride (VN), tantalum-nitride (TaN), molybdenum-nitride (MoN), yttrium barium copper oxide (Y—Ba—Cu—O), or another superconducting compound material. In some instances, the superconducting quantum circuit in a quantum processor chip 212 may include multilayer superconductor-insulator heterostructures.

In some implementations, the superconducting quantum circuit in a quantum processor chip 212 is fabricated on the top surface of the substrate and patterned using a microfabrication process or in another manner. For example, quantum circuit devices in a superconducting quantum circuit of a quantum processor chip 212 may be formed by performing at least some of the following fabrication steps: using chemical vapor deposition (CVD), physical vapor deposition (PVD), atomic layer deposition (ALD), spin-on coating, and/or other suitable techniques to deposit respective superconducting layers on the substrate; and performing one or more patterning processes (e.g., a lithography process, a dry/wet etching process, a soft/hard baking process, a cleaning process, etc.) to form openings in the respective superconducting layers.

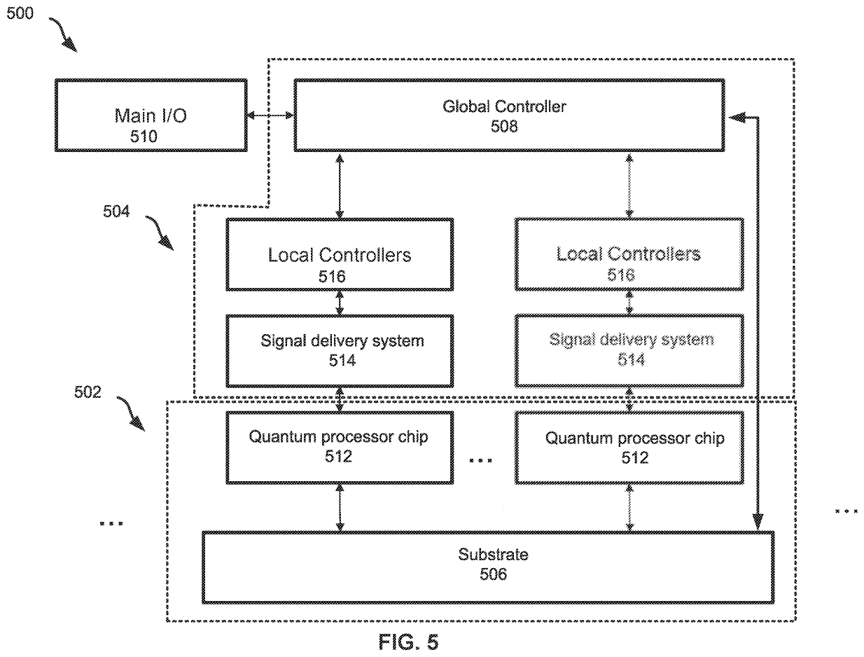

In the example shown in FIG. 2, a superconducting quantum circuit in each quantum processor chip 212 can operate as a logical qubit. In a particular example, each quantum processor chip 212 operates a patch of surface code at distance 17. In this case, the logical qubit is defined by the qubit devices in a single quantum processor chip 212 and includes approximately 577 qubits defined by the respective qubit devices of the single quantum processor chip 212. The respective qubit devices in the quantum processor chip 212 are communicably coupled with an associated signal delivery system and local controllers (e.g., the signal delivery system 514 and the local controllers 516 shown in FIG. 5 or another control system) via respective control lines. In certain instances, logic qubit errors at the boundary of quantum processor chips 212 can be decoded, incorporating specific properties of the inter-chip and intra-chip circuit connections. For example, a weighted graph decoder can assign higher weight values to connections corresponding to inter-chip error syndrome extraction which may have higher error rates due to more error prone inter-chip circuit connections. This may result in an overall higher effective physical error threshold, with the decoding task having the limiting case of decoding 2D syndrome graphs for perfect intra-chip error syndrome extraction. In some instances, decoding logical qubit errors allows for correlated error processes localized to one quantum processor chip 212.

In some implementations, the inter-chip circuit connections 206 on the substrate 204 are static low-dissipation connections. For example, an inter-chip circuit connection 206 may be a deterministic, low-loss wiring that can be configured to mediate coherent interactions between qubit devices from different quantum processor chips 212. In certain instances, the deterministic, low-loss wiring may include, for example, superconducting transmission lines, phononic or photonic waveguides, through-silicon vias, amplifiers, non-reciprocal elements such as circulators or isolators, switches, or another type of structure.

In some instances, the substrate 204 may further include a superconducting circuit that defines a switch network. In some instances, a switch network on the substrate 204 includes switch devices that determine a logical qubit connectivity graph, including relative orientation between quantum processor chips 212. In some instances, a quantum algorithm compilation includes configuring the switch network. In some instances, the modular quantum processing unit 200 includes multiple substrates 204, where each of the substrates 204 supports a subset of quantum processor chips 212 of the modular quantum processing unit 200. In this case, each of the substrates 204 includes a switch network that defines a portion of a logical qubit connectivity graph.

In some instances, the substrate 204 may further include a plurality of qubit devices that can be communicably coupled to a subset of quantum processor chips 212 of the modular quantum processing unit 200. In some instances, the qubit devices on the substrate 204 may be used to facilitate stabilizer measurements between a subset of quantum processor chips 212, for instance by participating as ancilla qubit devices used to measure stabilizer information for data qubit devices spanning one or more quantum processor chips 212. In some instances, the substrate 204 may further include other circuit elements.

In some cases, each quantum processor chip 212 is physically attached, bonded, or connected to the substrate 204. As shown in FIG. 2, the quantum processor chips 212 are bonded or attached to the substrate 204, for example, using bonding bumps. In some implementations, each of the bonding bumps may include conductive or superconductive materials, such as copper or indium bumps. In some implementations, the bonding bumps can provide electrical communication between the superconducting quantum circuits on the quantum processor chips 212 and the superconducting circuit on the substrate 204 (e.g., the inter-chip circuit connections 206. In some instances, quantum circuit devices in a superconducting quantum circuit of a quantum processor chip 212 may be communicably coupled, e.g., galvanically, capacitively, or inductively, to the circuitry on the substrate 204. The substrate 204 can provide functional connections (e.g., the inter-chip circuit connections 206) between distinct quantum processor chips 212 in a quantum processor module 202 as well as connections between the quantum processor chips 212 and the external control system.

In some examples, the superconducting circuit of the substrate 204 includes structures and circuit elements that provide control over the interactions between quantum circuit devices (e.g., qubit devices) in distinct quantum processor chips 212. In some implementations, the superconducting circuit on the substrate 204 may include a variety of circuit elements to control or readout the qubit devices of the quantum processor chips 212 in the quantum processor module 202. For example, the superconducting circuit may include flux bias lines which can provide magnetic flux locally to tunable-frequency qubit devices to tune their frequencies. The superconducting circuit may include tunable-frequency coupler devices, microwave feedlines, and resonator devices which are capacitively coupled to qubit devices to readout qubits. In some examples, the superconducting circuit may include microwave feedlines which are coupled to one or several of the resonator devices to allow microwave excitation of the resonator devices used to readout qubits. In this case, the superconducting circuit may include microwave drive lines which are capacitively coupled to qubit devices to drive qubits. The superconducting circuit may further include filters, isolators, circulators, amplifiers, or other circuit elements.

In some instances, the superconducting circuit on the substrate 204 may further include one or more electrically conductive vias. In some implementations, the electrically conductive vias include a superconducting material (e.g., Al, In, Ti, Pn, Sn, etc.). In some implementations, the superconducting circuit can be used as a Faraday cage, which can prevent stray electric fields from reaching the quantum circuit devices on the quantum processor chips 212. In some implementations, the superconducting circuit of the substrate 204 may also be used to exclude stray magnetic fields from reaching the quantum circuit devices on the quantum processor chips 212.

In some implementations, the superconducting circuit on the substrate 204 may be formed in one or more electrically conductive layers. In other implementations, each of the one or more electrically conductive layers may include a material that has normal conductance at the operating temperature of the example modular quantum processing unit 200. In some implementations, the example modular quantum processing unit 200 can be operated at cryogenic temperatures (e.g., cooled using liquid helium) and each of the one or more electrically conductive layers (or at least a portion) can operate as a superconducting layer at that temperature.

In some instances, quantum circuit devices in a quantum processor chip 212 may be coupled via alternative signal routing levels provided by the superconducting circuit on the substrate 204. For example, non-neighboring quantum circuit devices without qubit-to-qubit connections (e.g., without direct intra-chip circuit connections on the quantum processor chip 212) may be provided by the substrate 204. In some implementations, the superconducting circuit on the substrate 204 may be coupled to the superconducting quantum circuit on a quantum processor chip 212 using capacitive, inductive, or galvanic circuit connections. In some instances, the superconducting circuit may include planar transmission lines, for example coplanar waveguides, substrate integrated waveguides, or another type of planar transmission line.

In some implementations, a subset of the one or more electrically conductive vias are electrically coupled with external signal lines, which are used to supply control signals to, or retrieve readout signals from, the quantum processor chips 212 of a quantum processor module 202. For example, the control signals can be provided to the quantum processor chips 212 from a signal delivery system (e.g., the signal delivery system 514 of the quantum computing system 500) or the readout signals can be retrieved from the quantum processor chips 212 to the signal delivery system, directly or through the substrate 204 of the quantum processor module 202.

In some aspects of what is described here, the modular quantum processing unit 200 is an example of a multi-chip approach for superconducting qubit devices. A full-stack system can be designed and operated to reflect the specific functionalities of the quantum processor chips 212 and substrates 204 as an additional efficiency. End-user algorithms may be orchestrated on the modular quantum processing unit 200 via a control system (e.g., the global controller 508 in FIG. 5). In some instances, the control system may include a compiler providing compiled programs to the quantum processor chips.

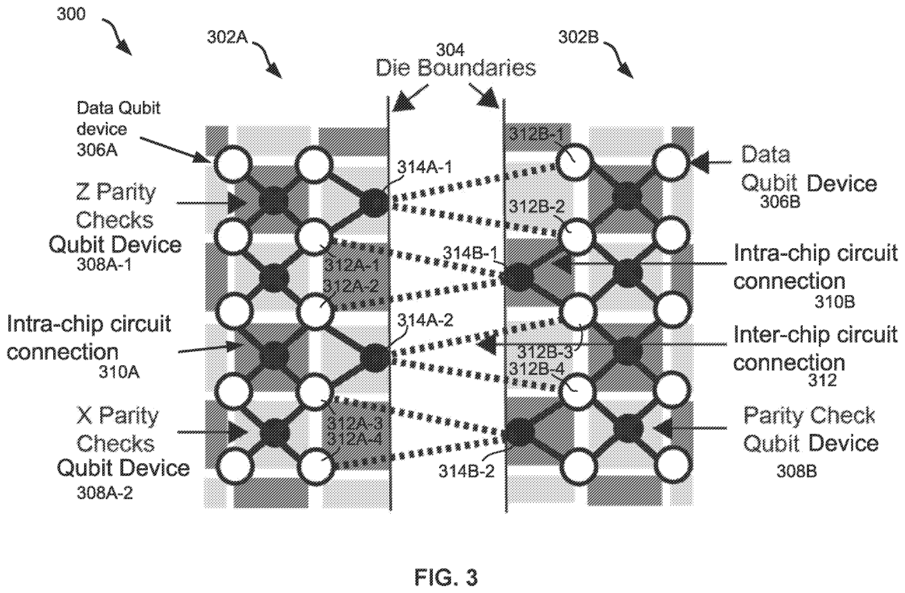

FIG. 3 is a block diagram showing aspects of an example modular quantum processing unit 300. The example modular quantum processing unit 300 includes multiple quantum processor chips on a substrate. As shown in FIG. 3, two of the multiple quantum processor chips are shown, e.g., a first quantum processor chip 302A and a second quantum processor chip 302B. The first and second quantum processor chips 302A, 302B are two neighboring quantum processor chips on the substrate of the modular quantum processing unit 300. In some instances, the two quantum processor chips 302A, 302B may not be neighboring quantum processor chips.

In some implementations, the first and second quantum processor chips 302A, 302B are implemented as the quantum processor chip 212 in the example modular quantum processing unit 200 as shown in FIG. 2. In some implementations, the example modular quantum processing unit 300 may include additional and different features or components, and components of the example modular superconducting quantum processing unit 300 may be implemented in another manner.

As shown in FIG. 3, each of the first and second quantum processor chips 302A, 302B includes a superconducting quantum circuit with multiple quantum circuit devices (e.g., qubit devices) connected in an error check pattern. In some implementations, a qubit device may be a data qubit device, a stabilizer/ancilla/parity-check qubit device, or other types of qubit devices. In particular, the first quantum processor chip 302A includes data qubit devices 306A (labeled as “unfilled” circles in FIG. 3), parity-check qubit device 308A (labeled as “filled” circles in FIG. 3), and intra-chip circuit connections 310A. Similarly, the second quantum processor chip 302B includes data qubit devices 306B, parity-check qubit device 308B, and intra-chip circuit connections 310B. Couplings provided by intra-chip circuit connections 310A, 310B can be used to apply multi-qubit quantum logic gates or other types of operations to qubits defined by qubit devices within the respective quantum processor chip 302A, 302B. Quantum logic gates mediated by intra-chip circuit connections 310A, 310B can be used to create entanglement between qubits defined by qubit devices within the respective quantum processor chip 302A, 302B.

As shown in FIG. 3, data qubit devices of the first quantum processor chip 302A further include four boundary data qubit devices 312A-1, 312A-2, 312A-3, and 312A-4; and parity-check qubit devices include two boundary parity-check qubit devices 314A-1 and 314A-2. Similarly, data qubit devices of the second quantum processor chip 302B includes four boundary data qubit devices 312B-1, 312B-2, 312B-3, and 312B-4; and parity-check qubit devices include two boundary parity-check qubit devices 314B-1 and 314B-2. As shown in FIG. 3, each boundary data qubit device is communicably connected to three parity-check qubit devices with the same quantum processor chip via respective intra-chip circuit connections 310 and connected to one boundary parity-check qubit device on a neighboring quantum processor chip via an inter-chip circuit connection 312; and each boundary parity-check qubit device 314A, 314B is communicably connected to two data qubit devices within the same quantum processor chip via intra-chip circuit connections 310 and two boundary data qubit devices on the neighboring quantum processor chip via inter-chip circuit connections 312.

As shown in FIG. 3, each of the boundary data and parity-check qubit devices on the first quantum processor chip 302A is communicably coupled to respective boundary data and parity-check qubit devices on the second quantum processor chip 302B via respective inter-chip circuit connections 312. Specifically, the parity-check qubit device 314A-1 of the first quantum processor chip 302A is communicably coupled to the boundary data qubit devices 312B-1 and 312B-2 on the second quantum processor chip 302B via respective inter-chip circuit connections 312; the parity-check qubit device 314A-2 of the first quantum processor chip 302A is communicably coupled to the boundary data qubit devices 312B-3 and 312B-4 on the second quantum processor chip 302B via respective inter-chip circuit connections 312; the parity-check qubit device 314B-1 of the second quantum processor chip 302B is communicably coupled to the boundary data qubit devices 312A-1 and 312A-2 on the first quantum processor chip 302A via respective inter-chip circuit connections 312; and the parity-check qubit device 314B-2 of the second quantum processor chip 302B is communicably coupled to the boundary data qubit devices 312A-3 and 312A-4 on the first quantum processor chip 302A via respective inter-chip circuit connections 312. In some instances, the boundary data qubit device of the quantum processor chips may be connected to other quantum circuit devices, for example, the superconducting circuit that reside on a common substrate supporting the two quantum processor chips 302A, 302B (e.g., the substrate 204 in FIG. 2). In some instances, the boundary data qubit devices may be connected to parity-check qubit devices of the superconducting circuity of the substrate via respective inter-chip circuit connections,

As shown in FIG. 3, the intra-chip circuit connections 310A, 310B (labeled in thick lines) represent physical connections between qubit devices on the same quantum processor chip. In some instances, intra-chip circuit connections may include circuit elements such as static capacitive coupling elements or tunable-frequency coupler devices, that support two-qubit/qudit quantum logic gates. As further shown in FIG. 3, the inter-chip circuit connections 312 (labeled in dashed lines) represent physical connections between qubit devices that reside on different quantum processor chips. Square tiles in FIG. 3 represent different patterns of parity checks, for instance ZZZZ (tiles in dark gray) or XXXX (tiles in light gray) parity checks in the case of the standard surface code. For each square tile, the parity-check qubit device (filled circle located at the center of a tile) performs a set of single and two-qubit quantum logic gates covering each of the data qubit devices on the corners of the same tile. The square tiles in the same color (dark or light gray) represent the prescribed pattern of quantum logic gates. In some implementations, for inter-chip parity checks, corresponding tiles may span two quantum processor chips, for example, via boundary data and parity-check qubit devices and respective inter-chip circuit connections.

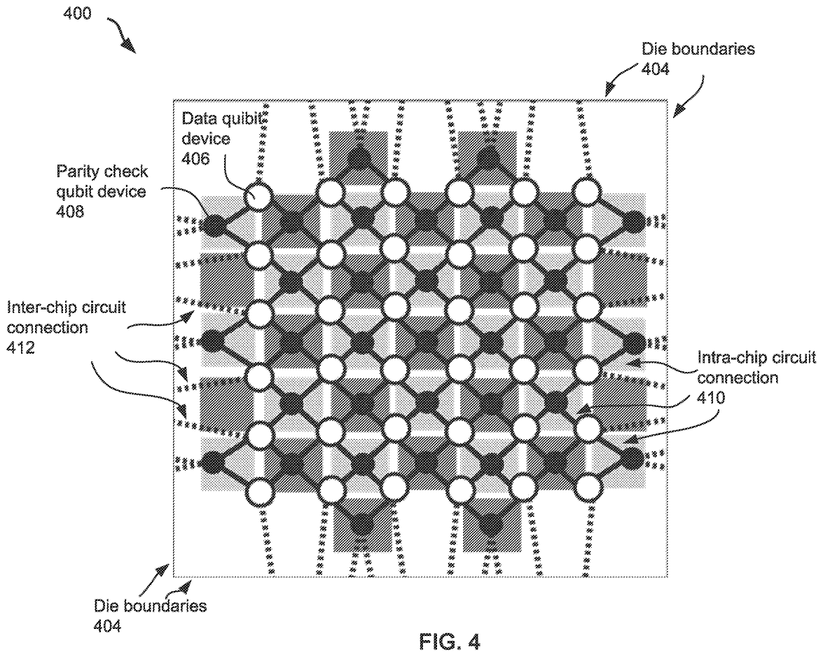

FIG. 4 is a schematic diagram of an example quantum error correction code (QECC) layout 400. The example QECC layout 400 includes patches of quantum error correction codes defined on a 2D lattice of qubit devices of a quantum processor chip. In some instances, the quantum processor chip on which the QECC layout 400 is applied can be patterned and fabricated on a singulated substrate. The quantum processor chip includes data qubit devices 406 and parity-check qubit devices 408 communicably coupled to the data qubit devices 406 via respective intra-chip circuit connections 410. In some implementations, qubit devices by the die boundaries 404 are further connected to qubit devices of neighboring quantum processor chips via respective inter-chip circuit connections 412. In some cases, the quantum processor chip can be implemented as the example quantum processor chip 212 as shown in FIG. 2 or in another manner. For example, the quantum error correction codes can be surface codes (e.g., distance 5, 21, or others) depending on the physical/logical error rates. In certain examples, the error correction codes can be other error correction codes, including those with two-dimensional connectivity graphs, such as 2D color codes.

The example QECC layout 400 shown in FIG. 4 supports distance 5 surface code quantum error correction. The distance is defined operationally as the number of physical errors that can accumulate before the logical state is corrupted beyond repair. Examples to define distance in surface code quantum error correction are described in the publication entitled “Surface codes: Towards practical large-scale quantum computation” by Fowler et al. (Phys. Rev. A 86, 032324, 2012), in the publication entitled “Low-distance Surface Codes under Realistic Quantum Noise” by Tomita et al. (arXiv: 1404.3747v3 [quant-ph], Apr. 14, 2014), and in the publication entitled “Deep neural decoders for near term fault-tolerant experiments” by Chamberland et al. (arXiv: 1802.06441v2 [quant-ph], Feb. 18, 2018).

Using multiple distinct levels and types of quantum error correction codes is compatible with these techniques. For example, a Bacon-Shor code may be constructed as an outer layer around quantum processor chips running a quantum error correction code (e.g., a 2D surface code). In this case, the connectivity between a quantum processor chip and associated controller hardware may reflect the desired error check pattern of the quantum error correction code, e.g., the weight of connections on the boundary qubit devices.

As shown in FIG. 4, performing parity check operations by operation of parity-check qubit devices occur in patterns, for instance ZZZZ alternating with XXXX, when applying quantum error correction. The presence or absence of errors in the physical qubit devices (gates or measurements) can be detected as a change in the stabilizer measurement sequence, for instance observing (a−1) stabilizer outcome when (a+1) outcome is anticipated. In some instances, a decoding algorithm can be executed to determine what the most likely root-cause error is. In certain instances, corrective action, e.g., the application of quantum logic gates, or an update to the post-processing sequence, can be performed in response. Examples for performing quantum error correction are described in the publication entitled “Surface codes: Towards practical large-scale quantum computation” by Fowler et al. (Phys. Rev. A 86, 032324, 2012), in the publication entitled “Low-distance Surface Codes under Realistic Quantum Noise” by Tomita et al. (arXiv: 1404.3747v3 [quant-ph], Apr.14, 2014), and in the publication entitled “Deep neural decoders for near term fault-tolerant experiments” by Chamberland et al. (arXiv: 1802.06441v2 [quant-ph], Feb. 18, 2018),

FIG. 5 is a block diagram showing aspects of an example computing system 500. The example computing system 500 includes a quantum processor module 502 and a control system 504. The example quantum processor module 502 includes a set of quantum processor chips 512 communicably coupled to and bonded on a substrate 506. In some implementations, each of the quantum processor chips 512 includes a superconducting quantum circuit with multiple quantum circuit devices and provides the functionality of a logical qubit. In some implementations, qubit devices from different quantum processor chips are connected in an error check pattern and can support a single logical qubit. In some implementations, the quantum processor module 502 is part of a modular quantum processing unit, e.g., the example modular quantum processing unit 200 as shown in FIG. 2 or in another manner. As shown in FIG. 5, the control system 504 includes a global controller 508, local controllers 516, and signal delivery systems 514 for the respective quantum processor chips 512 in the quantum processor module 502. In some implementations, certain aspects or components of the control system 504 can be implemented as described with respect to the control system 105 as shown in FIG. 1, or in another manner. The computing system 500 further includes a main input/output (I/O) interface 510. In some implementations, the substrate 506 can be a crystalline substrate (e.g., silicon or sapphire), or another type of substrate (e.g., fused silica or fused quartz). In certain instances, the substrate 506 may be implemented as the substrate 204 in FIG. 2. In some implementations, the example computing system 500 may include additional and different features or components and components of the example computing system 500 may be implemented in another manner. For example, the computing system 500 may include a modular quantum processing unit which includes multiple quantum processor modules 502.

In some aspects of what is described here, each of the quantum processor chips 512 of the quantum processor module 502 is associated and communicably coupled to a respective local controller 516 through a signal delivery system 514. In some instances, the control system 504 delivers control signals to, or receives readout signals from, the quantum processor chips 512 via the substrate 506. In certain instances, the signal delivery system 514 includes connector hardware elements which include signal lines, signal processing hardware, filters, feedthrough devices (e.g., light-tight feedthroughs, etc.), and other types of components. In some implementations, the connector hardware elements of the signal delivery system 514 can span multiple different temperature and noise regimes. For example, the connector hardware elements can include a series of temperature stages operating at different temperatures, e.g., 60 Kelvin (K), 3 K, 800 milli Kelvin (mK), 150 mK, that decrease between a higher temperature regime of the global and local controllers 508, 516 and a lower temperature regime of the modular quantum processing unit 502. In some instances, components of the local controllers 516 can operate in a room temperature regime, an intermediate temperature regime, or both. For example, the local controllers 516 can be configured to operate at much higher temperatures and be subject to much higher levels of noise than are present in the environment of the quantum processor module 502.

In some implementations, the quantum processor module 502, and all or part of the signal delivery systems 514, can be maintained in a controlled cryogenic environment. The environment can be provided, for example, by shielding equipment, cryogenic equipment, and other types of environmental control systems. In some examples, the components in the quantum processor module 502 operate in a cryogenic temperature regime and are subject to very low electromagnetic and thermal noise. For example, magnetic shielding can be used to shield the system components from stray magnetic fields, optical shielding can be used to shield the system components from optical noise, and thermal shielding and cryogenic equipment can be used to maintain the system components at controlled temperatures, etc.

In some instances, information is encoded in the qubit devices in a quantum processor chip 512, and the information can be processed by operation of the qubit devices in the superconducting quantum circuit of the quantum processor chip 512. For instance, input information can be encoded in the computational states or computational subspaces defined by some or all of the qubit devices in the quantum processor chip 512. The input information can be processed, for example, by applying a quantum algorithm or other operations.

In some aspects of operation, the local controller 516 sends control signals to the qubit devices in a quantum processor chip 512. The control signals can be configured to manipulate the qubits defined by the qubit devices. In some implementations, a control signal can be a direct current (DC) signal communicated from the local controller 516 to the individual qubit device. In some implementations, a control signal can be an alternating current (AC) signal communicated from the local controller 516 to the individual qubit device. In some cases, the AC signal may be superposed with a direct current (DC) signal. Other types of control signals may be used. In some instances, the local controller 516 identifies a quantum logic gate to be applied to qubit devices and possibly other quantum circuit devices in respective quantum processor chips 512. The local controller 516 can perform the quantum logic gate operations by communicating the control signals to a control line that is coupled to the qubit device in a quantum processor chip 512 of the example modular quantum processing unit 502. In certain instances, the local controllers 516 shown in FIG. 5 may include, for example, a signal generator system, a program interface, a signal processing system, and possibly other components.

The substrate 506 may include signal lines and circuit devices, which can be of the same type as the circuit devices on the quantum processor chips 512 (e.g., qubit devices, readout devices, etc.). The substrate 506 may include bond pads which may be arranged such that each of the quantum processor chips 512 can be placed and bonded with good electrical contact and micron-scale alignment accuracy. In some instances, the quantum processor chip 512 may communicate with the circuit devices via the signal lines on the substrate 506. In some instances, the quantum processor chips 512 are also communicably coupled to one another via the signal lines or possibly the circuit devices on the substrate 506. The signal lines 506 may be implemented as superconducting traces or other types of conductive structures. In some cases, the signal lines are routed three-dimensionally through the substrate 506 (e.g., through all or part of the thickness of the substrate 506), allowing for arbitrary connectivity architectures.

In some instances, the substrate 506 may include a resonator bus which has many modes. The resonator bus may allow for a higher bandwidth of coupling between the different quantum processor chips 512. For example, to maintain high-connectivity, a bus of resonators may be used to couple qubit devices between different quantum processor chips 512 within a modular quantum processing unit 502. The number of resonator modes in a resonator bus may determine the number of simultaneous two-qubit operations that are possible. In some cases, transmission lines can be routed in three dimensions within the substrate 506 allowing for a wider range of connectivity architectures, such that couplings can be generated between non-immediate-neighbor quantum processor chips, for example.

In some implementations, to operate planar surface codes across the modular quantum processing unit 502, only boundary qubit devices on neighboring quantum processor chips 512 need to be communicably coupled to one another. Higher-dimensional codes may require more connectivity between the quantum processor chips 512. Wiring between quantum processor chips 512 can be facilitated by the substrate 506. For example, the substrate 506 may include ancilla qubit patches, each of which includes one or more ancilla qubit devices, associated control signal lines, and measurement circuitry. In some instances, an ancilla qubit patch can be initialized into the code, and used to fault-tolerantly extend or move quantum information across different quantum processor chips 512. For another example, the substrate 506 may include deterministic, low-loss wiring to mediate coherent interactions between qubit devices from different quantum processor chips 512. In certain instances, the deterministic, low-loss wiring may include, for example, superconducting transmission lines, phononic waveguides, or another type of structure. When a boundary qubit device is connected to more than one neighboring quantum processor chips 512, the boundary qubit device may have higher connectivity than the intra-chip qubit devices (e.g., a total number of intra-chip circuit connections and inter-chip circuit connections of a boundary qubit device may be greater than four). This reduces the physical overhead and latency of operating the quantum processor module 502. In certain examples, the substrate 506 may include multi-layer wiring, to facilitate signal routing and to achieve multiple module-to-module connections.

In some implementations, the substrate 506 includes a switch network that controls the inter-chip circuit connections among quantum processor chips 512. The switch network may be a high-speed (e.g., nanoseconds) low-dissipation cryogenic switch network. For example, the switch network may include switches that are Josephson junction-based which includes SQUID loops. For another example, switches of the switch network may be transistor-based, e.g., complementary metal-oxide-semiconductor (CMOS) devices or high-electron mobility transistor (HEMT) devices. In some implementations, the switch network can reduce the physical overhead of the quantum processor module 502 by improving on typical planar connectivity of qubit devices for superconducting processors. In some instances, the connections provided by the switch network between quantum processor chips 512 can be configured by the global controller 508 and may be modified during operation of the modular quantum processing unit, for example when executing a quantum algorithm. Multiple relative orientations between quantum processor chips 512 may also be supported to reduce the need for rotating logical qubits.

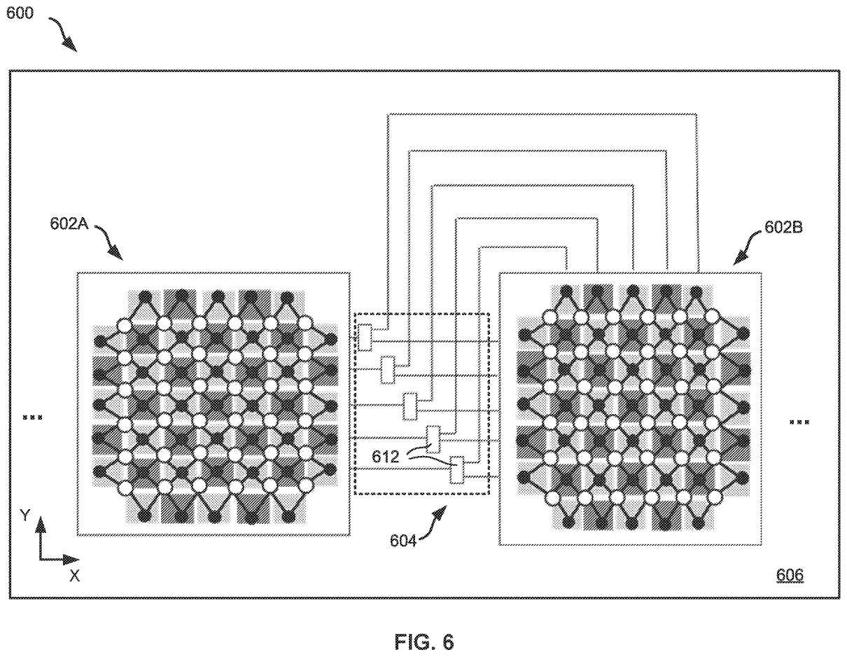

In some implementations, a switch network toggles coupling between qubit devices on the boundaries of quantum processor chips 512, rather than all of possible combinations of qubit devices on the multi-chip processor. This feature may be attractive for logical qubit algorithms spanning a plurality of quantum processor chips 512 because the boundary qubit devices are the ones that are deployed for logical qubit entanglement methods, such as lattice surgery, rather than all of the qubit devices in the quantum processor chips 512. Separate quantum processor chips are an important enabler for switch-based technologies since these can generate nonequilibrium quasiparticles (e.g., SQUIDs) or are a different manufacturing process than what is typically used for superconducting qubit devices (e.g., HEMT), Examples of generating nonequilibrium quasiparticles is described in the publication entitled “Digital coherent control of a superconducting qubit” by Leonard et al. (arXiv:1806.07930v1 [quant-ph], Jun. 20, 2018), In some implementations, switches in a switch network may enable multiple inter-chip circuit connections within a clock cycle of a quantum error correction scheme to facilitate high-weight parity check operations. In certain instances, the switch network may not be supported by the substrate 506. For example, the switch network may be a part of the control system located at an elevated temperature. In this case, the substrate 506 can interface with the switch network or communicate with the switch network in another manner. In some instances, the switch network may be implemented as the switch network 604 in FIG. 6 or in another manner.

In some implementations, the global controller 508 and the local controllers 516 are optimized for the modular quantum processing unit 502 by localizing computing/signal processing/signal generation to reflect the configuration of individual quantum processor chip 512 (e.g., high-speed, low-latency distributed computations and communication between qubit devices on a respective quantum processor chip 512 and a respective local controller 516). In some instances, the switch network on the substrate 506 providing inter-chip circuit connections between quantum processor chips 502 includes cryogenic switches operating in a cryogenic environment.

In some implementations, the computing system 500 includes one or more decoders associated with the quantum processor chips 512 of the quantum processor module 502. The one or more decoders are configured to process error syndromes when applying quantum error correction according to properties of inter-chip or intra-chip circuit connections. For example, if inter-chip circuit connections in a region of a quantum processor module 502 where multiple quantum processor chips 512 are connected have much higher error rates, decoders can emphasize this region. For example, a higher threshold value of the effective error can be assigned for these inter-chip circuit connections, since the 1D boundary is a lower-dimensional problem. In some implementations, a decoder allows for one quantum processor chip 512 to suffer an irrecoverable error. For instances, an irrecoverable error can be induced by high energy radiation and can be localized to a single quantum processor chip 512 by physical mechanisms (e.g., indium bumps as phononic low-pass filters as in other multi-module configurations). In some implementations, the one or more decoders include a weighted graph decoder including weights assigned to the respective inter-chip circuit connections and the respective intra-chip circuit connections. In some instances, the one or more decoders include other types of decoders or may be implemented in another manner.

FIG. 6 is a schematic diagram showing aspects of an example quantum processor module 600. The example quantum processor module 600 includes multiple quantum processor chips 602 on a substrate 606. As shown in FIG. 6, two of the multiple quantum processor chips are shown, e.g., a first quantum processor chip 602A and a second quantum processor chip 602B. The first and second quantum processor chip 602A, 602B are two neighboring quantum processor chips on the modular quantum processing unit 600. In some instances, the two quantum processor chips are not neighboring quantum processor chips.

In some implementations, the first and second quantum processor chips 602A, 602B are implemented as the quantum processor chip 212 in the example modular quantum processing unit 200 as shown in FIG. 2. The substrate 606 may be implemented as the substrate 204, 506 in FIGS. 2, 5 or in another manner. In some implementations, the example quantum processor module 600 may include additional and different features or components, and components of the example quantum processor module 600 may be implemented in another manner.

As shown in FIG. 6, each of the first and second quantum processor chips 602A, 602B includes a superconducting quantum circuit with multiple quantum circuit devices (e.g., qubit devices, coupler devices, readout devices, etc.) and connections. In particular, each of the first and second quantum processor chips 602A, 602B includes data qubit devices (labeled as “unfilled” circles in FIG. 6), parity-check qubit device (labeled as “filled” circles in FIG. 6), and intra-chip circuit connections (solid lines between circles in FIG. 6). Couplings provided by intra-chip circuit connections 310A, 310B can be used to apply multi-qubit quantum logic gates or other types of operations to qubits defined by qubit devices within the same quantum processor chip. Quantum logic gates mediated by intra-chip circuit connections can be used to create entanglement between qubits defined by qubit devices within the same quantum processor chip. In some implementations, the quantum processor chips 602A, 602B can be implemented as the quantum processor chips 302A, 302B in FIG. 3 or in another manner.

In some implementations, the first and second quantum processor chips 602A, 602B are connected via a switch network 604 with multiple switches 612. In some implementations, the switch network 604 is a cryogenic switch network, for example, supported on the substrate 606, which operates together with the quantum processor chips 602A, 602B at a cryogenic temperature. As shown in FIG. 6, the switch network 604 is a 1:2 switch matrix. The parity-check qubit devices (filled circles) along one die boundary of the first quantum processor chip 602A are connected to the parity-check qubit devices along two neighboring die boundaries of the second quantum processor chip 602B through the switch network 604. The switch network 604 enables inter-chip circuit connections between logical qubits collectively defined by respective qubit devices of the two quantum processor chips 602A, 602B, for instance through lattice surgery. In some implementations, the switch network 604 defines the relative orientation between the logical qubits. In some examples, logical Z operators are defined along one axis (e.g., Y-axis) within each quantum processor chip and logical X operators are defined along an orthogonal axis (e.g., X-axis) Common techniques for achieving general two-qubit quantum logic gates between the logical qubits would require rotating the basis for one or more of these qubit devices, changing the assignment of logical operator to effective physical axis for one or more logical qubits, relative to a subset of other logical qubits. This can be done over several effective clock cycles using initialization and measurement steps. Examples for performing effective clock cycles is described in the publication entitled “A Game of Surface Codes: Large-Scale Quantum Computing with Lattice Surgery” by Litinski (arXiv: 1808.02892v3 [quant-ph], Aug. 8, 2018). In some implementations, an effective rotation in zero clock cycles is achieved by operation of the switch network. For example, an effective rotation can be achieved by toggling between relative orientations, by operation of the switch devices 612 of the switch network 604. In some instances, the switches 612 are supported on the substrate 606, and their states (e.g., directionality) are determined and controlled by receiving control signals from the external control system. In some instances, the external control system may include a compiler. In some implementations, the compiler is used to determine strategies and sequences of inter-chip circuit connections between the quantum processor chips 602A, 602B to optimize the execution of a quantum algorithm, e.g., by increasing parallelism. In other words, the connections, for example, defined by the switch devices 612 of the switch network 604 is controlled by operation of the control system according to the quantum algorithm for processing quantum information. The connectivity of the quantum processor chips 602A, 602B, as well as connectivity to other quantum processor chips within the example quantum processor module 600 can be tracked and updated at a clock cycle time compatible with the speed of executing quantum logic gates on the quantum processor chips 602A, 602B of the quantum processor module 600.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, logical qubit hardware modules are operated in a modular quantum processing unit.

In a first example, a computing system includes a modular quantum processing unit and a control system communicably coupled to the modular quantum processing unit. The modular quantum processing unit includes a plurality of quantum processor chips, and a substrate that supports the plurality of quantum processor chips. Each quantum processor chip includes a superconducting quantum circuit; and each superconducting quantum circuit includes quantum circuit devices and intra-chip circuit connections between respective pairs of the quantum circuit devices within the superconducting quantum circuit. The quantum circuit devices include a plurality of qubit devices. The substrate includes circuitry which includes inter-chip circuit connections between respective pairs of the quantum circuit devices across distinct superconducting quantum processor chips. The control system is configured to process quantum information by operation of the modular quantum processing unit. The control system is configured to process the quantum information by processing logical qubits, and operation of the modular quantum processing unit includes a definition of each of the logical qubits on a respective subset of the plurality of quantum processor chips; and an application of quantum error correction to the logical qubits defined by each respective subset of the plurality of quantum processor chips. As used herein, a definition of a logical qubit may refer to data or circuitry that maps or otherwise associates a logical qubit to the physical qubit devices that may reside on one or more quantum processor chips. In some cases, the definition may map a logical qubit to each of the physical qubits in a quantum processor chip. In some cases, the definition may map a logical qubit to a subset of physical qubits in a quantum processor chip. In some cases, the definition may map a logical qubit to physical qubits located in two or more quantum processor chips.

Implementations of the first example may include one or more of the following features. The plurality of qubit devices in each superconducting quantum circuit is connected in an error check pattern. The control system is configured to apply a quantum error correction scheme to each superconducting quantum circuit based on the error check pattern. The quantum error correction scheme includes a surface code or a color code.

Implementations of the first example may include one or more of the following features. The plurality of quantum processor chips is bonded to the substrate. The inter-chip circuit connections include at least one of capacitive, inductive, or galvanic circuit connections. The control system includes a global controller and a plurality of local controllers; and each of the quantum processor chips is associated with a respective one of the plurality of local controllers. The control system includes a plurality of signal delivery systems; and each of the plurality of signal delivery systems delivers signals between a respective one of the quantum processor chips and its associated local controller.

Implementations of the first example may include one or more of the following features. The control system is configured to modify the respective inter-chip circuit connections during operation of the modular quantum processing unit. The substrate includes a switch network that controls the inter-chip circuit connections and defines a logical qubit connectivity graph. The switch network includes a cryogenic switch network. The switch network includes a plurality of switch devices configured to enable at least a subset of the inter-chip circuit connections within a clock cycle of a quantum error correction scheme. The control system is configured to process the quantum information based on applying a quantum algorithm; and controlling the switch network according to the quantum algorithm.

Implementations of the first example may include one or more of the following features. During operation of the modular quantum processing unity, the inter-chip circuit connections mediate coherent interactions between qubit devices in distinct quantum processor chips. The quantum processor chips reside in a cryogenic environment at a first temperature; and the control system includes a switch network residing in a distinct environment at a second temperature greater than the first temperature. The control system is configured to process the quantum information based on applying a quantum logic circuit to the logical qubits; and the quantum logic circuit includes single-qubit quantum logic gates, multi-qubit quantum logic gates, and readout operations.

Implementations of the first example may include one or more of the following features. The control system includes one or more decoders associated with the quantum processor chips; and application of the quantum error correction includes operation of the one or more decoders to process error syndromes. The one or more decoders include a weighted graph decoder including weights assigned to the respective inter-chip circuit connections and the respective intra-chip circuit connections. The weights represent higher error thresholds for inter-chip operations, relative to lower error thresholds for intra-chip operations.

Implementations of the first example may include one or more of the following features. Each of the quantum processor chips includes boundary qubit devices; and the boundary qubit devices of distinct quantum processor chips are connected to each other by the inter-chip circuit connections. Each of the quantum processor chips includes parity-check qubit devices; and application of the quantum error correction includes operation of the parity-check qubit devices to perform parity check operations. The respective subset of the plurality of quantum processor chip is a quantum processor chip or multiple quantum processor chips.

In a second example, a computing system includes a first subset of quantum processor chips, a second subset of quantum processor chips, and a substrate. The first subset of quantum processor chips includes first superconducting quantum circuits. Each of the first superconducting quantum circuits includes a first set of qubit devices. The first superconducting quantum circuits are configured to support a first logical qubit operated according to a first quantum error correction scheme. The second subset of quantum processor chips includes second superconducting quantum circuits. Each of the second superconducting quantum circuits includes a second set of qubit devices. The second superconducting quantum circuits are configured to support a second logical qubit operated according to a second quantum error correction scheme. The substrate is configured to support the first and second subsets of quantum processor chips and includes inter-chip connections between the first and second superconducting quantum circuits.

Implementations of the second example may include one or more of the following features. Each of the first superconducting quantum circuits includes first intra-chip circuit connections between respective pairs of qubit devices in the first set of qubit devices. Each of the second superconducting quantum circuits includes second intra-chip circuit connections between respective pairs of qubit devices in the second set of qubit devices. The first set of qubit devices are connected in a first error correcting pattern; and the second set of qubit devices are connected in a second error correcting pattern.

Implementations of the second example may include one or more of the following features. The computing system includes a control system communicably coupled to the first and second subsets of quantum processor chips. The control system is configured to process quantum information based on operation of the first and second subsets of quantum processor chips. The control system is configured to process the quantum information based on processing the first and second logical qubits; and operating the first and second subsets of quantum processor chips includes an application of the first and second quantum error correction schemes to the first and second logical qubits. Each of the first and second quantum error correction schemes includes a surface code or a color code. The substrate includes a switch network that controls the inter-chip circuit connections and defines a logical qubit connectivity graph. Each of the first and second subsets of quantum processor chips is a quantum processor chip or multiple quantum processor chips.

In a third example, a computer-readable medium includes first quantum processor chip data and second quantum processor chip data. The first quantum processor chip data characterizes a first subset of quantum processor chips; and the second quantum processor chip data characterizes a second subset of quantum processor chips. The first quantum processor chips include first superconducting quantum circuits. The first superconducting quantum circuits are configured to support a first logical qubit operated according to a first quantum error correction scheme. The second quantum processor chips include second superconducting quantum circuits. The second superconducting quantum circuits are configured to support a second logical qubit operated according to a second quantum error correction scheme. The first and the second subsets of quantum processor chips are supported on a substrate with inter-chip circuit connections between the first and the second superconducting quantum circuits.

Implementations of the third example may include one or more of the following features. The first quantum processor chip includes first quantum circuit devices; and the second quantum processor chip includes second quantum circuit devices. The first quantum processor chip includes first intra-chip circuit connections between respective pairs of the first quantum circuit devices; and the second quantum processor chip includes second intra-chip circuit connections between respective pairs of the second quantum circuit devices. Each of the first and second quantum error correction schemes includes a surface code or a color code. The substrate includes a switch network that controls the inter-chip circuit connections and defines a logical qubit connectivity graph. Each of the first and second subsets of quantum processor chips is a quantum processor chip or multiple quantum processor chips.

In a fourth example, a computing system includes a modular quantum processing unit including a plurality of quantum processor chips and means for operating the modular quantum processing unit based on logical qubits. Each of the logical qubits is supported by a respective subset of the plurality of quantum processor chips.

Implementations of the fourth example may include one or more of the following features. Each quantum processor chip includes a superconducting quantum circuit, and each superconducting quantum circuit includes quantum circuit devices including a plurality of qubit devices, and intra-chip circuit connections between respective pairs of the quantum circuit devices within the superconducting quantum circuit.

Implementations of the fourth example may include one or more of the following features. The modular quantum processing unit includes a substrate that supports the plurality of respective quantum processor chips and includes circuitry. The circuitry includes inter-chip circuit connections between respective pairs of the quantum circuit devices in distinct quantum processor chips. The substrate includes a switch network that controls the inter-chip circuit connections and defines a logical qubit connectivity graph. The means for operating modular quantum processing unit includes a control system communicably coupled to the modular quantum processing unit. The control system is configured to process quantum information based on operation of the modular quantum processing unit. The control system is configured to process the quantum information based on processing logical qubits; and operating the modular quantum processing unit is based on a definition of the logical qubits on the respective quantum processor chips; and an application of quantum error correction to a logical qubit defined by each respective quantum processor chip. The respective subset of the plurality of quantum processor chips is a quantum processor chip or multiple quantum processor chip.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A computing system comprising:
a modular quantum processing unit comprising:
a plurality of quantum processor chips, each quantum processor chip comprising a superconducting quantum circuit, each superconducting quantum circuit comprising:
quantum circuit devices comprising a plurality of qubit devices; and
intra-chip circuit connections between respective pairs of the quantum circuit devices within the superconducting quantum circuit; and
a substrate that supports the plurality of quantum processor chips and comprising circuitry, the circuitry comprising inter-chip circuit connections between respective pairs of the quantum circuit devices in distinct quantum processor chips; and
a control system communicably coupled to the modular quantum processing unit, the control system configured to process quantum information based on operation of the modular quantum processing unit, wherein the control system is configured to process the quantum information based on processing logical qubits, and operation of the modular quantum processing unit is based on:
a definition of each of the logical qubits on a respective subset of the plurality of quantum processor chips; and
an application of quantum error correction to the logical qubits defined by each respective subset of the plurality of quantum processor chips.

2. The system of claim 1, wherein the plurality of qubit devices in each superconducting quantum circuit are connected in an error correcting pattern, and the control system is configured to apply a quantum error correction scheme to each superconducting quantum circuit based on the error correcting pattern.

3. The system of claim 2, wherein the quantum error correction scheme comprises a surface code or a color code.

4. The system of claim 1, wherein the plurality of quantum processor chips is bonded to the substrate, and the inter-chip circuit connections comprise at least one of capacitive, inductive, or galvanic circuit connections.

5. The system of claim 1, wherein the control system comprises a global controller and a plurality of local controllers, and each one of the plurality of quantum processor chips is associated with a respective one of the plurality of local controllers.

6. The system of claim 5, wherein the control system comprises a plurality of signal delivery systems, and each of the plurality of signal delivery systems delivers signals between a respective one of the quantum processor chips and its associated local controller.

7. The system of claim 1, wherein the control system is configured to modify the respective inter-chip circuit connections during the operation of the modular quantum processing unit.

8. The system of claim 7, wherein the substrate comprises a switch network that controls the inter-chip circuit connections and defines a logical qubit connectivity graph.

9. The system of claim 8, wherein the switch network comprises a cryogenic switch network.

10. The system of claim 8, wherein the switch network comprises a plurality of switches configured to enable at least a subset of the inter-chip circuit connections within a clock cycle of a quantum error correction scheme.

11. The system of claim 8, wherein the control system is configured to process the quantum information based on applying a quantum algorithm and controlling the switch network according to the quantum algorithm.

12. The system of claim 1, wherein, during the operation of the modular quantum processing unity, the inter-chip circuit connections mediate coherent interactions between qubit devices in distinct quantum processor chips.

13. The system of claim 1, wherein the plurality of quantum processor chips resides in a cryogenic environment at a first temperature, and the control system comprises a switch network residing in a distinct environment at a second temperature greater than the first temperature.

14-29. (canceled)

30. A computer-readable medium comprising:
first quantum processor chip data characterizing a first subset of quantum processor chips comprising first superconducting quantum circuits, the first superconducting quantum circuits being configured to support a first logical qubit operated according to a first quantum error correction scheme; and
second quantum processor chip data characterizing a second subset of quantum processor chips comprising second superconducting quantum circuits, the second superconducting quantum circuits being configured to support a second logical qubit operated according to a second quantum error correction scheme, wherein the first and the second subsets of quantum processor chips are supported on a substrate with inter-chip circuit connections between the first and the second superconducting quantum circuits.

31. The computer-readable medium of claim 29, wherein the first quantum processor chip comprises first quantum circuit devices; and the second quantum processor chip comprises second quantum circuit devices.

32. The computer-readable medium of claim 30, wherein the first quantum processor chip comprises first intra-chip circuit connections between respective pairs of the first quantum circuit devices; and the second quantum processor chip comprises second intra-chip circuit connections between respective pairs of the second quantum circuit devices.

33. The computer-readable medium of claim 29, wherein each of the first and second quantum error correction schemes comprises a surface code or a color code.

34. The computer-readable medium of claim 29, wherein the substrate comprises a switch network that controls the inter-chip circuit connections and defines a logical qubit connectivity graph.

35. The computer-readable medium of claim 29, wherein each of the first and second subsets of quantum processor chips is a quantum processor chip.

36. The computer-readable medium of claim 29, wherein each of the first and second subsets of quantum processor chips is multiple quantum processor chips.

37-43. (canceled)
